(19) United States
(12) Patent Application Publication
(10) Pub. No.: US 2006/0013680 A1
(43) Pub. Date: Jan. 19, 2006

(54) Chip handling methods and apparatus

(75) Inventors: Belgacem Haba, Saratoga, CA (US); David B. Tuckerman, Orinda, CA (US); Glenn Urbish, Coral Springs, FL (US); Masud Beroz, Livermore, CA (US); Ilyas Mohammed, Santa Clara, CA (US)

Correspondence Address: TESSERA;LERNER DAVID et al., 600 SOUTH AVENUE WEST, WESTFIELD, NJ, 07090, US

(73) Assignee: Tessera, Inc., San Jose, CA (US)

(21) Appl. No.: 11/183,635

(22) Filed: Jul. 18, 2005

Related U.S. Application Data
(60) Provisional application No. 60/588,420, filed on Jul. 16, 2004.

(51) Int. Cl. B65G 49/07

(52) U.S. Cl. 414/935

(57) ABSTRACT

An array of chips spaced apart from one another by chip spacing distances, as, for example, an array of chips on a wafer dicing tape is juxtaposed with an array of chip receiving elements spaced apart from one another by receiving element spacing distances different from the chip spacing distances, as, for example, an array of substrates or fixtures spaced apart from one another at distances substantially larger than the chip spacing distances. The juxtaposing step is performed so that a set of chips including less than all of the chips in the array of chips is aligned with a set of the chip receiving elements. This set of chips is transferred to the set of chip receiving elements while the arrays are aligned with one another. The cycle may be repeated using the same or different array of chips, and using the same or different array of chip receiving elements. Numerous small chips can be transferred to large chip receiving elements without handling individual chips, and without the use of equipment such as pick-and-place equipment commonly used for such handling.

### CROSS-REFERENCE TO RELATED APPLICATIONS

The present application claims the benefit of the filing date of U.S. Provisional Patent Application No. 60/588,420, filed Jul. 16, 2004, the disclosure of which is hereby incorporated by reference herein.

### FIELD OF THE INVENTION

The present invention relates to microelectronic packaging.

### BACKGROUND OF THE INVENTION

Semiconductor chips typically are mounted to substrates which serve to protect the chip and to connect the chip to other elements of an electronic circuit. Chips are almost universally formed by processing a large semiconductor wafer to form numerous regions, each including the microscopic circuitry of a single chip, and then cutting or “dicing” the wafer to form numerous separate chips. Each such chip includes a flat, typically rectangular body having front and rear surfaces and contacts on the front surface connected to the microscopic circuitry within the chip. A bare chip resulting from the dicing operation may be converted to a packaged chip by uniting the chip itself with protective elements such as a small circuit panel commonly referred to as a package substrate having electrically-conductive terminals, and electrically connecting the contacts of the chip to the terminals on the packaged substrate. A packaged chip can, in turn, be mounted to a larger substrate such as a large circuit panel. Alternatively, a bare or unpackaged chip can be mounted to a larger circuit panel. Typically, each packaged or unpackaged chip is handled as a separate unit during operations such as packaging and during mounting of a packaged or unpackaged chip to a circuit panel. For example, chips can be placed onto circuit boards using pick-and-place equipment, which typically handles one chip at a time.

It has been proposed heretofore to perform some operations while the chips remain in the form of a wafer. For example, as disclosed in certain embodiments of U.S. Pat. No. 5,518,964, a large sheet incorporating numerous package substrates may be united with a wafer, and the terminals throughout the sheet may be electrically connected to contacts of all of the chips in the wafer. The resulting assembly can then be severed to form individual units, each including a single chip and a single packaged substrate. This approach, of course, avoids the operations required to handle individual chips during the process of attaching the chip to the package substrate. However, this approach yields a package substrate having an area substantially equal to the area of the chip itself, i.e., equal to the area of the chip front surface. This is advantageous in many applications.

For some applications, however, packaged or unpackaged chips must be mounted to substrates having area larger than the area of the chip itself. For example, certain radio frequency identification (“RFID”) tags incorporate relatively small chips mounted to large substrates in the form of large circuit panels. Each circuit panel has conductors which define an antenna for transmission and receipt of radio frequency signals. Typically, the antenna must have dimensions substantially larger than the dimensions of the chip itself, and hence, the substrate must be substantially larger than the chip. Some RFID tags must be manufactured in large numbers and at a very low cost.

It would be highly desirable to provide improved methods and apparatus for chip handling and mounting which avoid the inefficiencies inherent in handing individual chips, but which can mount chips to substrates larger than the chips themselves.

### SUMMARY OF THE INVENTION

One aspect of the present invention provides a method of handling chips. The method according to this aspect of the invention desirably includes a cycle of operations. The cycle includes juxtaposing an array of chips spaced apart from one another by chip spacing distances with an array of chip receiving elements spaced apart from one another by receiving element spacing distances. The juxtaposing step desirably is performed so that a set of chips including a plurality of chips, but less than all of the chips in the array, is aligned with a set of the chip receiving elements. The cycle of operations desirably further includes the step of transferring the set of chips to the set of chip receiving elements while the arrays are aligned with one another. The method desirably further includes repeating this cycle of operations using the same or a different array of chips, and using the same or a different array of chip receiving elements so as to transfer a different set of chips to chip receiving elements in each cycle.

The receiving element spacing distances are different from the chip spacing distances. The array of chips typically has the chips at very close spacings. For example, the array may be an array derived from a wafer by dicing the wafer while holding the individual chips on a dicing tape. Such an array may have the chips spaced at chip spacing distances comparable to the distances between individual chips in a wafer. The receiving element spacing distances may be considerably larger than the chip spacing distances. For example, the receiving elements may include a strip or sheet of substrates such as RFID antennas and may be spaced apart from one another by receiving element spacing distances comparable to the dimensions of an individual substrate. Alternatively, the receiving elements may include holding fixtures spaced apart from one another by relatively large distances, as, for example, magazines or pockets spaced apart from one another.

Methods according to this aspect of the invention allow for simultaneous mounting or transfer of numerous individual chips without the need for handling the individual chips by themselves.

A method according to a further aspect of the invention includes the step of juxtaposing a carrier having chips at a plurality of chip locations with a plurality of chip receiving elements, and transferring the chips from the carrier to the chip receiving elements only at a first set of chip locations without transferring chips from the carrier at a second set of chip locations interspersed with the first set of chip locations. For example, where the chips are positioned on a dicing tape, chips may be transferred from the dicing tape only at a few locations spaced apart from one another while leaving chips at intermediate locations. The transferring step may include engaging the carrier with a tool having active elements spaced apart from one another so that the active elements are aligned with the first set of chip locations, but not with a second set of chip locations interspersed with the first set.

Still further aspects of the present invention provide techniques for mounting acoustically active chips and assemblies including such acoustically active chips.

These and other objects, features and advantages of the present invention will be more readily apparent from the detailed description set forth below, taken in conjunction with the accompanying claims.

### BRIEF DESCRIPTION OF THE DRAWINGS

FIG. 1 is a diagrammatic plan view of a wafer.

FIG. 2 is a diagrammatic plan view of a chip array formed from the wafer of FIG. 1.

FIG. 3 is a diagrammatic plan view depicting the array of FIG. 2 in conjunction with an array of chip receiving elements during one step of a method in accordance with one embodiment of the present invention, certain elements being shown as transparent for clarity of illustration.

FIG. 4 is a diagrammatic, partially exploded view depicting the arrays of FIGS. 2 and 3 in conjunction with a tool.

FIG. 5 is a view similar to FIG. 3, but depicting the arrays during a subsequent stage of the method.

FIG. 6 is a view similar to FIGS. 3 and 5, but depicting the arrays at a still later stage of the method.

FIG. 7 is a diagrammatic perspective view depicting an array and tool used in a further embodiment of the invention.

FIG. 8 is a diagrammatic plan view of a chip array used in accordance with a further embodiment of the invention.

FIG. 9 is a diagrammatic sectional view depicting the chip array of FIG. 8.

FIG. 10 is a view similar to FIG. 8, but depicting the chip array in conjunction with a tool.

FIG. 11 is a diagrammatic sectional view depicting the chip array and tool of FIG. 10 in conjunction with a chip receiving element.

FIG. 12 is a diagrammatic plan view of the array of chip receiving elements depicted in FIG. 11 at a later stage in the method.

FIG. 13 is a diagrammatic sectional view depicting the array of FIG. 12 in conjunction with an array of substrates during a still later stage of the method.

FIG. 14 is a diagrammatic perspective view of an array of chip receiving elements usable in further embodiments of the invention.

FIG. 15 is a diagrammatic sectional view of a chip array used in a method according to a further embodiment of the invention.

FIGS. 16 and 17 are diagrammatic sectional views depicting the arrays of FIG. 15 in conjunction with an array of substrates at successive stages of the method.

FIGS. 18 and 19 depict the chip array of FIGS. 15-17 in conjunction with a different array of substrates during a later stage of the method.

FIG. 20 is a sectional view depicting an array of chip bearing substrates shown in conjunction with a further element during a later stage of the method.

FIG. 21 is a sectional view depicting the array of FIG. 20 during a still later stage of the method.

FIG. 22 is a detailed sectional view on an enlarged scale depicting one unit shown in FIG. 21.

### DETAILED DESCRIPTION OF THE PREFERRED EMBODIMENTS

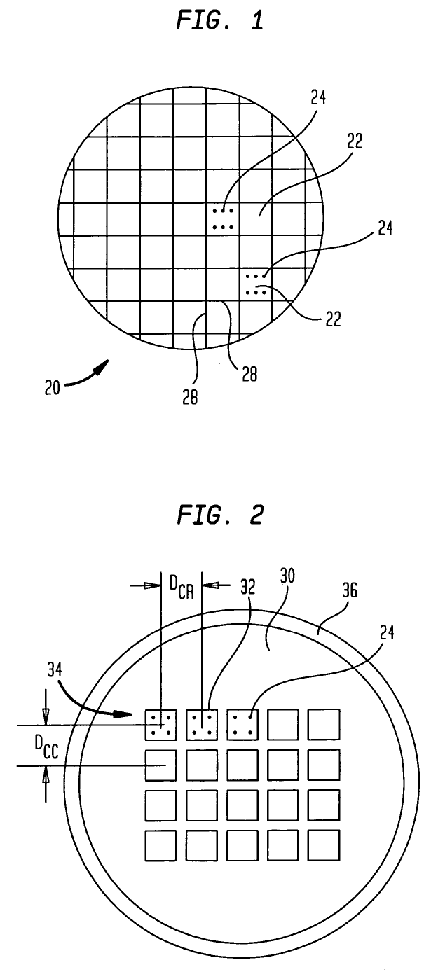

A process in accordance with one embodiment of the invention begins with a wafer 20 (FIG. 1) which incorporates numerous individual regions 22. Each such region includes internal electronic circuitry (not shown) and contacts 24 on a front surface. Only a few of the contacts 24 are depicted for clarity of illustration. The boundaries 28 between individual regions 22 may or may not be visible in the wafer. The wafer has a rear surface (not shown) opposite from the front or contact-bearing surface visible in FIG. 1.

In the first step of the process, as shown in FIG. 2, the rear surface of the wafer is mounted to a membrane-like carrier 30 by adhesively bonding the rear surface to the surface of the carrier. The carrier may be a flexible film of the type commonly used in the semiconductor industry as a “dicing tape.” With the rear surface of the wafer mounted to the dicing tape, the wafer is severed to form an array of individual chips 32 by conventional processes such as sawing or etching the material of the wafer along the boundaries 28, between the individual regions 22 (FIG. 1) of the wafer. The individual chips 32 retain the original spatial arrangement of the regions in the wafer. That is, the chips 32 form an array 34 with rows and columns of chips corresponding to the rows and columns of individual regions 22 in the wafer. The spacing distances between adjacent chips in the array 34 on carrier 30 correspond to the spacing distances between adjacent regions 22 within the wafer 20 (FIG. 1). That is, when the wafer is initially severed to form the individual chips, the center-to-center distance or pitch D_{cr} between adjacent chips 32 in a row is equal to the corresponding spacing between adjacent chips 32 in a single row on the wafer 20, whereas the center-to-center distance or pitch D_{cc} between adjacent chips 32 in a column of array 34 on carrier 30 is equal to the corresponding distance between adjacent chips in a single column on the wafer 20. Carrier 30 desirably is mounted in a substantially rigid frame 36, such as a metallic ring.

In a variant of this process, membrane 30 may be stretched in a uniform manner after severing the wafer, so as to slightly increase one or both of spacing distances D_{cr} and D_{cc} uniformly throughout the array, and then mounted to frame 36 in the stretched condition. Even in this variant, however, the individual chips 32 remain in the form of the array imparted by the original wafer 20. Although only four rows and five columns of chips are depicted in FIG. 2 for clarity of illustration, it should be appreciated that the array 34 may include all of the chips formed in an individual wafer, which may be many hundreds or even thousands of chips. Alternatively, the array 34 may include only a portion of the chips formed in the wafer. For example, the wafer may be pre-severed so as to form a smaller wafer portion, including numerous rows of individual regions 22, and this smaller portion of the wafer may be mounted to carrier 30 and severed as discussed above to form the array 34.

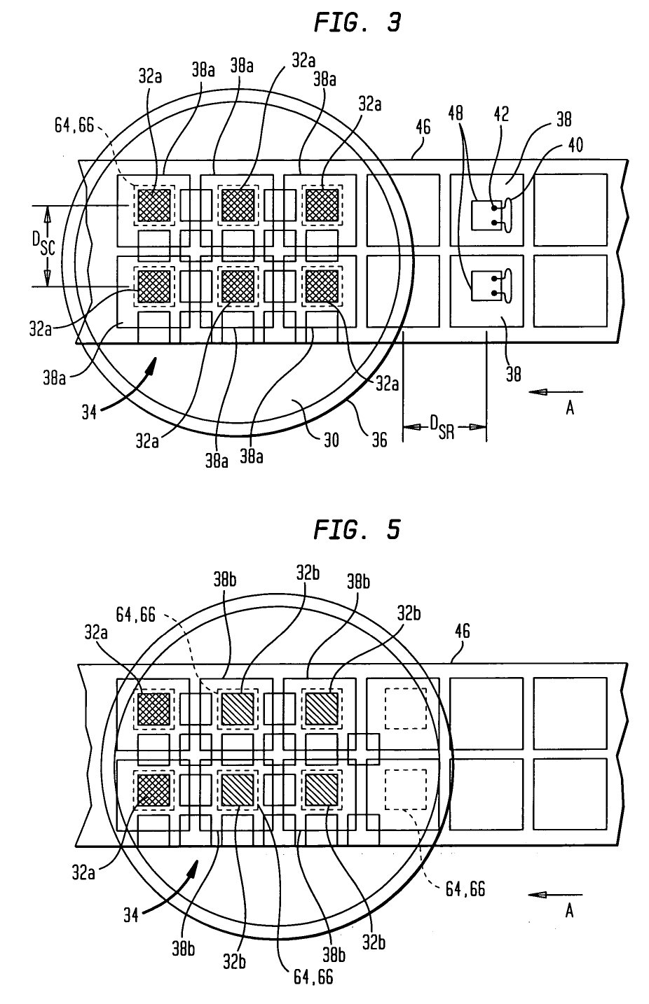

In the next stage of the process (FIG. 3), the array 34 of chips on carrier 30 is juxtaposed with an array of chip-receiving elements, which in this case, are substrates 38 having electrically-conductive elements such as antenna elements 40 and connectors 42 suitable for mounting and electrical connection to the contacts 24 (FIGS. 1 and 2) of the individual chips. For clarity of illustration, the electrically-conductive elements 40 and 42 of the individual substrates are depicted in only two of the substrates 38 and omitted from the depictions of the other substrates. However, these elements are present all of the substrates. Substrates 38, at this stage of the process, are in the form of a continuous or semi-continuous elongated sheet or tape 46, only a portion of which is shown in FIG. 3. Typically, such a sheet or tape includes a dielectric layer which may be rigid or, more preferably, flexible and one or more layers of metal defining the electrically-conductive features 40 and 42 of the individual substrate. The continuous sheet or tape 46 may also include features such as sprocket holes (not shown) for feeding or moving the tape in the lengthwise direction (to the left and right in FIG. 3). Each substrate 38 carries a region of anisotropic conductive adhesive 48 overlying the connectors 42. Anisotropic conductive adhesives per se are well known in the art. They are arranged to have substantial electrical conductivity in the direction through the layer of adhesive, but very low conductivity in the direction parallel to the surfaces of the layer. For example, an anisotropic conductive adhesive may include a layer of a dielectric polymeric adhesive with conductive particles dispersed therein. The particles may have diameters comparable to the layer thickness.

The individual substrates are disposed in an ordered array within sheet or tape 46. In this array, two rows of substrates 38 extend in the lengthwise direction of the sheet, and numerous columns are spaced along the lengthwise directions of the sheet. Each substrate 38 is substantially larger than each chip 32, and hence, the spacing between adjacent substrates 38 is substantially larger than the spacing between adjacent chips 32 in array 34. In the embodiments depicted, the center-to-center spacing distance between adjacent substrates 38 in a single row Dₛᵣ is twice the center-to-center spacing distance D_{cr} (FIG. 2) between adjacent chips 32 in a single row of array 34. Also, in this example, the center-to-center spacing D_{sc} between adjacent substrates 38 in a single column of the substrate array is twice the center-to-center spacing distance D_{cc} (FIG. 2) in adjacent chips 32 of the chip array 34. The 2:1 ratio is only exemplary; desirably, Dₛᵣ is any multiple of D_{cr}, desirably an integral multiple of D_{cr}, whereas D_{sc} is any multiple, desirably an integral multiple, of D_{cc}. The multiples applied to the rows may be same as, or different from, the multiple applied to the columns.

As shown in FIG. 3, the sheet 46 or array of substrates 38 is aligned with the array 34 of chips so that a first set of chips 32a, cross-hatched in FIG. 3 for clarity of illustration, is aligned with a first set of substrates 38a. That is, each chip 32a at a first set of locations within array 34 is properly aligned with a substrate 38a within array 46. Thus, each chip 32a is positioned relative to a substrate 38a so that the contacts 24 (FIGS. 1 and 2) of that chip are aligned with the connectors 42 of the particular substrate, and so that the chip is aligned with an adhesive area 48 on the substrate. However, other chips 34, interspersed with the chips 32a of the first set, are not properly aligned with substrates.

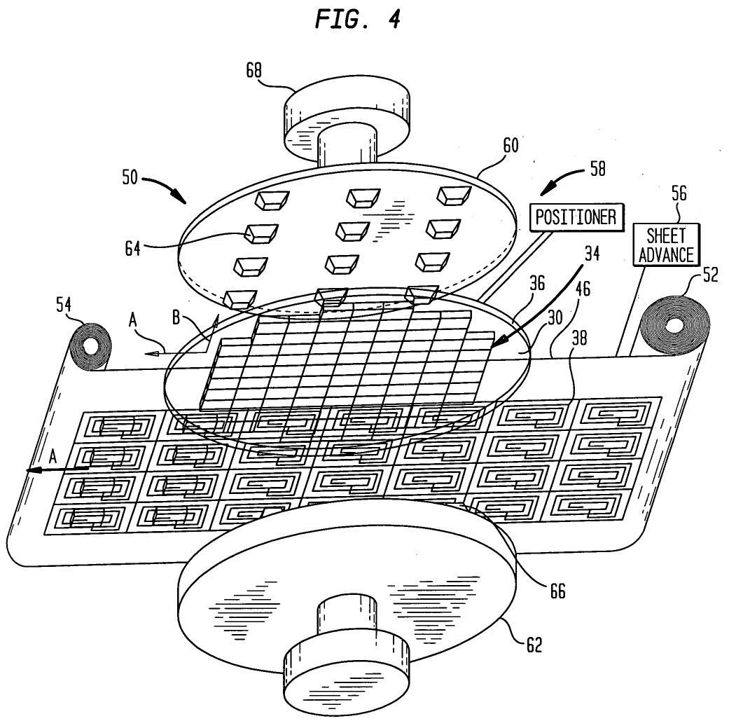

The chip array and substrate array are aligned with a tool 50 or tools having active, operative elements 64, 66, shown in broken lines in FIG. 3, aligned with the chips 32a of the first set. For example, as seen in diagrammatic perspective view in FIG. 4, the sheet or substrate array 46 may be fed intermittently from a supply reel 52 in a lengthwise, downstream direction, indicated by arrow A in FIG. 4, towards a take-up reel schematically shown at 54 by tape-feed “sheet advance” mechanism 56. The tape feeding mechanism may include conventional elements for advancing the supply roll 52 and take-up reel 54, and may also include conventional elements for engaging and supporting the sheet 46, as for example, elements for engaging sprocket holes and intermittently moving the tape or sheet 46. The carrier 30 holding chip array 34 is mounted on a positioning device (“positioner”) 58, which may be any form of conventional positioning device, engaged with the frame 36 holding the carrier. Positioning device 58 is arranged to support the chip array over the path of the advancing sheet or tape substrate array 46.

Tool 50 may include a pair of platens 60 and 62 having projections 64 and 66 on their operative faces. The platens 60 and 62 are held in a press schematically indicated at 68, so that the operative face of platen 60 is disposed above the carrier 30 held on positioning device 58, whereas the operative face of platen 66 lies below the path of the advancing sheet or substrate array 46. The operative, active features such as projections 64 and 66 on the tool are disposed at spacings corresponding to the row and column spacings of the substrate array.

While the chip and substrate array in the alignment discussed above with reference to FIG. 3, platens 60 and 62 are advanced towards one another so as to force the chips 32a of the first set into engagement with the substrates, and hence, into engagement with the anisotropic conductive adhesive 48 on those substrates. Where the anisotropic adhesive is heat-activated, platens 62 and 64 may be heated to activate the adhesive and facilitate the bonding process. Only those chips 32a disposed at the first set of locations will be engaged by the projecting features 64 and 66 of the platens, and therefore, only those chips will be bonded to substrates. The other chips in array 34 are not bonded to substrates in this operation. The bonding process also serves to electrically connect the contacts of the first set of chips 32a to the electrically-conductive features, such as the connectors 42 and antennas 40 included in the individual substrates. The mechanical engagement and heat applied by the platens also act to de-bond the chips of the first set 32a from the carrier 30. The platens 32 are then retracted away from the carrier and substrate array. Optionally, positioning device 58 advances the chip array downwardly toward the substrate array prior to or during engagement of the platens, and retracts the carrier 30 upwardly away from the substrate array during disengagement of the platens.

The bonding operation, thus, transfers only those chips 32a of the first set to substrates 38 which are aligned with those chips. The remaining chips of array 34 remain attached to carrier 30 and remain as part of the array.

In the next stage of the process, positioner 58 moves the chip carrier 30 and the chip array 34 (now without the chips 32a previously transferred to substrates) in the downstream indicated by arrow A through a distance equal to D_{CR}, i.e., the center-to-center distance between adjacent chips in a row of the chip array 34, so as to position a second set of chips 38b (FIG. 5) in alignment with the operative elements 64, 66 of the tool. The substrate array, or sheet 46, is advanced downstream in direction A until the chip array 34 and substrate array reaches the position illustrated in FIG. 5. In this position, the second set of chips 32b is aligned with a second set of substrates 38b of the substrate array 46. In the condition shown in FIG. 5, the chips of the first set 32a have shifted in the downstream direction A, along with the substrate array, or sheet 46. Two of these chips are visible at the left in FIG. 5. These chips no longer form part of chip array 34.

In this condition, chips 32b of the second set are aligned with the active, operative features 64, 66 of the tool, whereas the other chips remaining in array 34 are not aligned with the operative features of the tool. The tool is operated again by advancing the platens 60 and 62 as discussed above. In this operation, only the chips 32b of the second set will be transferred to substrates 38b of the substrate array 46, whereas other chips in array 34 will not be transferred. A few active elements 64, 66 at the upstream edge of the tool may not be aligned with any portion of the chip array, and hence, will not transfer chips during this operation.

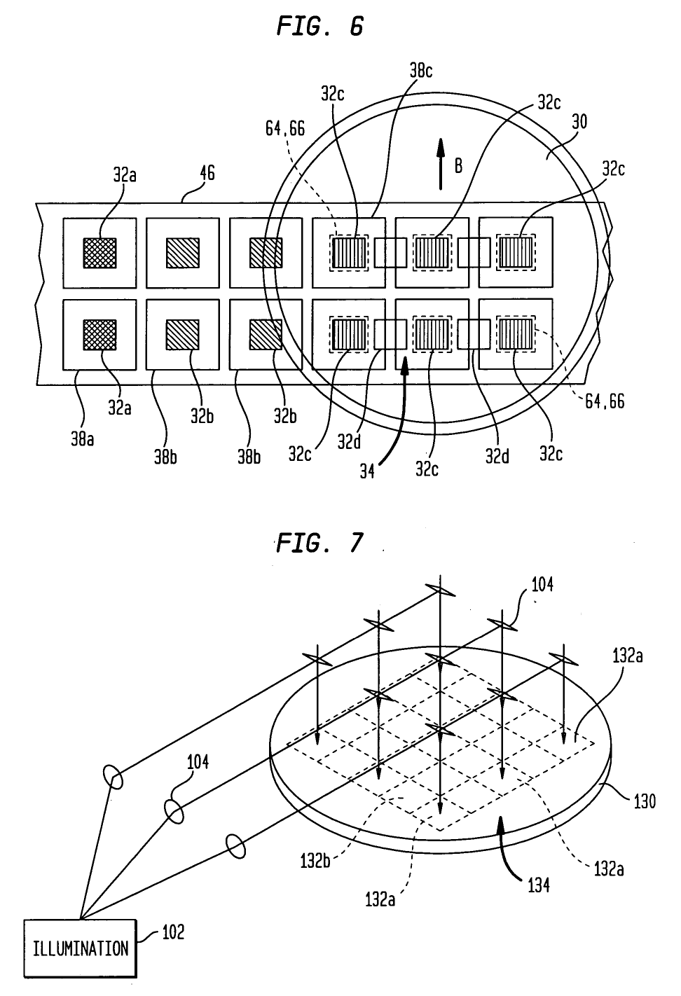

After transfer of the chips 32b of the second set, the sheet or substrate array 46 is again moved downstream in direction A by the sheet advance mechanism 56. During this movement, positioner 58 shifts the carrier 30 bearing the chip array (now without chips 32a and 32b of the first and second sets) laterally, in a direction B (FIGS. 4 and 6), transverse to the downstream direction A. This shifting movement desirably is through a distance equal to an integral number of chip column spacing distances D_{cc} (FIG. 2). In this instance, the integral number is 1; carrier 30 and array 34 are displaced by one chip column spacing distance D_{cc} in FIG. 6 from the position occupied in FIG. 5. Positioner 58 also moves the chip array upstream relative to the tool 50 through one chip row spacing distance D_{CR} so as to align a third set of chips 32c with the active elements 64, 66 of the tool.

The combined motions of the chip array and substrate array bring the chip array and substrate array to the condition illustrated in FIG. 6. In this condition, chips 32c of the third set are aligned with substrates 38c of a third set of substrates on the substrate array 46, whereas other chips within array 34 are not aligned with substrates. Here again, the aligned chips and substrates are also aligned with the active, operative elements 64, 66 of the tool, so that when the tool operates, the chips 32c of the third set are transferred to the substrates or chip-receiving elements 38 in the manner discussed above, whereas other chips are not transferred.

After this operation, the substrate array 46 is again moved in the downstream direction A. Once again, the positioner 58 (FIG. 4) shifts the chip array 34 downstream so that the chips 32d of a fourth set of chips are again aligned with the operative elements 64, 66 of the tool. Here again, the chips 32d of the fourth set are transferred. Here again, the chips of the fourth set are aligned with substrates of a fourth set (not shown) in the same substrate array or strip 46 and transferred to the substrates.

Thus, on each cycle of actuation of the tool, a set of chips aligned with the tool is transferred to the substrate, but such transfer occurs at only some locations of the chip array. Chips present in the array at other locations are not transferred. The motion of the chip array relative to the tool is selected so that the set of chips to be transferred in a particular cycle is aligned with the active elements of the tool during every cycle. The motion of the chip array relative to the substrate, resulting from the combined motion of the chip array and substrate relative to the tool, is selected so that the set of chips to be transferred in a particular cycle is always aligned with a set of substrates.

The net result is to transfer individual sets of chips to individual sets of substrates without handling individual chips separately from the array. This process thus provides a simple and economical method of moving the chips from an array of chips onto an array of substrates.

The same sequence of operations, of course, can be repeated again using further arrays of chips. Thus, all of the substrates in a continuous length of substrate array or sheet 46 may be provided with chips. The completed, chip-bearing substrates passing downstream from the transferring operation can be wound onto the take-up roll 54 or cut from the sheet and used as desired.

The particular movements discussed above can be varied considerably. For example, the substrate array may remain stationary and the tool and chip array may be moved relative to one another and relative to the substrate array to accomplish the same relative motions as discussed above and the same series of alignment steps. Conversely, the chip array may remain stationary, and the substrate array and tool may move relative to the chip array, both in the lengthwise (upstream and downstream) directions and in the lateral direction. In the process discussed above, the movements of the various components are intermittent. However, the same approach can be applied where the substrate array, chip array or both move in a continuous motion. In that instance, the chip array would move downstream along with the substrate array during each transfer operation so as to maintain the alignment between the chips and substrate, and the tool would also move along with the chip array during the transfer operation.

In the embodiment discussed above with reference to FIGS. 1-6, the same operation which acts to physically transfer the chips from the chip array, and from carrier 30, to the substrates also serves to make the electrical connections between the chip contacts and the electrically-conductive features of the substrates. However, this is not essential. For example, the chips may be physically attached to the substrates by activating a non-conductive adhesive on the substrates or on the chips during the transfer operation. The transferred chips may then be electrically connected to the conductive features of the substrates in a subsequent operation performed at a location downstream from the transfer operation. For example, the chips or the substrate may be provided with a heat-activatable electrically-conductive bonding material such as a solder or a eutectic bonding alloy, and this may be activated by passing the substrates through a heating device such as an oven positioned downstream of the transferring tool.

In a process according to a further embodiment, as illustrated in FIG. 7, the carrier 130 is in the form of a transparent element such as a glass, sapphire or polymeric solid wafer-like element. Here again, the wafer is bonded to the carrier with the rear surface of the wafer facing toward the carrier. However, the adhesive used to bond the wafer to the carrier is selected so that it is degradable by radiant energy such as ultraviolet light in a selected band of degradation wavelengths. The carrier is transparent to light in that band. Once again, the wafer is cut to form an array 134 of individual chips on the carrier. In the transferring operation, the carrier, with the array of chips thereon, is again positioned relative to the substrate so that a particular subset of chips in the array, such as chips 132a, are aligned with substrates (not shown), whereas other chips, such as chips 132b, are not aligned with substrates. While the array is aligned with the array of substrates, radiant energy is applied from a source 102 through carrier 132. The radiant energy is applied selectively only to those locations within the array occupied by the chips of the first set 132a and is not applied at other locations. This causes detachment of the chips 132a of the first set, so that the chips 132a of the first set are selectively transferred from the array to the substrates or chip-receiving elements, whereas other chips in the array, such as chips 132b, are not transferred.

In the embodiment depicted, the illumination source 102 is directed through a set of mirrors 104, schematically shown in FIG. 7. However, any optical system capable of selectively directing light from the illumination source may be used. For example, a mask may be aligned with the carrier, such mask having openings only at locations of the first set of chips 132a. In these arrangements, and in the arrangements discussed above with reference to FIGS. 1-6, all of the chips of a given set are transferred simultaneously by operation of the tool or by application of radiant energy. However, it is not essential to transfer all of the chips in each set simultaneously. For example, in an optical arrangement as discussed with reference to FIG. 7, the illumination source may be arranged to illuminate the various locations of the first set seriatim rather than simultaneously. For example, a beam of radiant energy may be scanned by a moving mirror over the surface of the carrier 130 and pulsed, so that the beam illuminates only the locations of the first set. In a subsequent cycle, the beam is scanned in a similar manner and pulsed in a different pattern so as to illuminate only the locations of a second set, and so on.

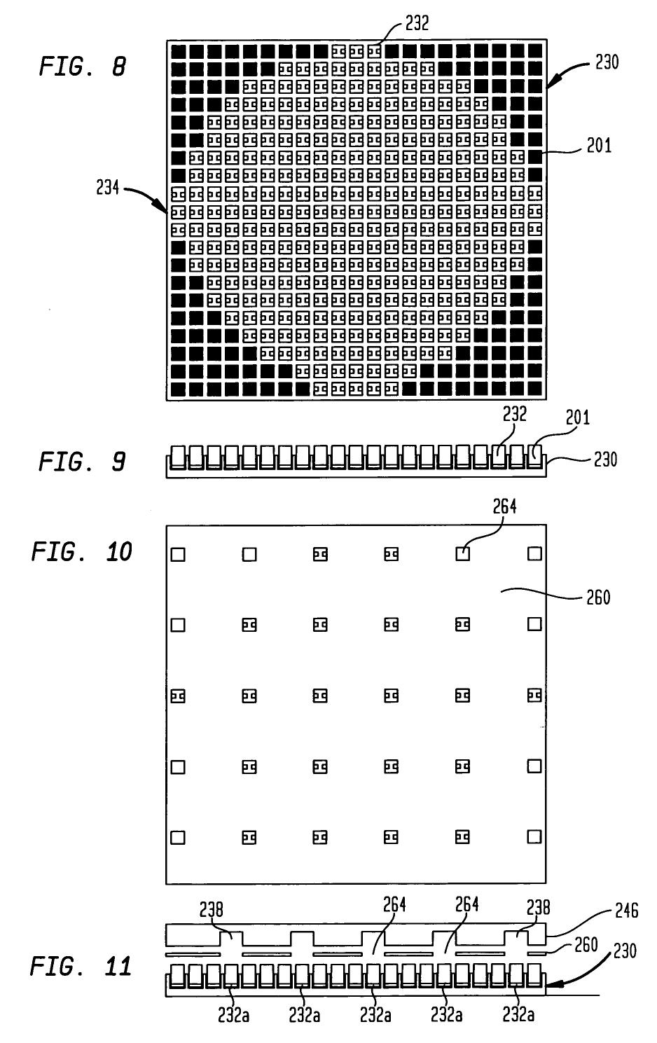

A process according to a further embodiment of the invention uses an array 234 of individual chips 232 held in a carrier 230 (FIGS. 8 and 9). In this instance, the carrier 230 is a tray having individual pockets 201. Preferably, the starting array 234 is formed by transferring an entire array of chips derived from a wafer or a portion of a wafer into the pockets 201, without handling the individual chips themselves. For example, a wafer may be bonded to a carrier such as the carrier 130 discussed above with reference to FIG. 7 using a degradable adhesive. The wafer may then be severed to form individual chips as discussed above, thus providing an array of chips on the carrier. The entire array may be aligned with carrier 230, and the bond between the chips and carrier may be released non-selectively, as for example, by illuminating or heating the entire carrier, so that all of the chips are transferred into the pockets 201 of the carrier 230.

The array of chips shown in FIGS. 8 and 9 is then used as a starting array for a transfer-and-placement process which may be similar to the process discussed above. Here again, individual sets of the chips in the array are transferred to sets of chip-receiving elements. However, in the transfer process of this embodiment, the chip-receiving elements are not the ultimate substrates to which the chips are to be mounted and connected. Instead, as shown in FIGS. 10 and 11, an array 246 of fixtures 238 in the form of pockets is employed as the array of chip-receiving elements. The array 246 of chip-receiving elements 238 may be formed as a unitary tray as, for example, a molded plastic tray. Here again, the chip-receiving elements or pockets 238 are disposed in the array 246 at spacings different from the spacings of the individual chips in array 234 on carrier 230. A tool 260 in the form of a stencil having active or operative elements 264 in the form of holes extending through the stencil is used to provide selective transfer of only a set of chips from the chip array 234. Here again, the chip array 234 is aligned with the array of pockets or chip-receiving elements 238, so that a first set of chips 232a (FIG. 11) is aligned with the chip-receiving elements or pockets 238. The stencil or tool 260 is also aligned with the chip array so that the operative elements or holes 264 in the stencil are aligned with the locations carrying the chips 232a of the first set. The assembly is then inverted so as to drop the chips 232a of the first set into the chip-receiving elements or pockets 238. In this operation, the other chips are retained by the stencil, and hence, are not transferred from the chip array on carrier 230 into the chip-receiving elements 238.

After the transfer, the array of chip-receiving elements 246 has the first set of chips 232a disposed thereon, in the pockets 238 as seen in FIG. 12. As seen in this drawing, the chips 232a of the first set are now disposed as spacings corresponding to the spacings between the chip-receiving elements in pockets 238. These spacings are considerably larger than the spacings between the chips 232 in the original array 234, and in the original wafer used to make array 234. As seen in FIG. 13, the chips contained in the array of chip-receiving elements or pockets 238 may be transferred non-selectively to an array of substrates 239, such as an array of substrates forming a portion of a continuous sheet or tape, simply by engaging the array of pockets 238 with the array of substrates and transferring all of the chips in this array non-selectively to substrates 239. The same array 246 of chip-receiving elements 238 may be used in a subsequent cycle to accept additional chips from array 234. In this additional cycle, the array of chip-receiving elements or pockets 238 is aligned with a second set of chips in array 234, and once again, the active elements or holes 264 in the tool or stencil 260 are aligned with the set of chips to be transferred, and the process is repeated so as to transfer the chips of the second set from array 234 into chip-receiving elements or pockets 238. Of course, a different set of chip-receiving elements, such as a different tray 246, may be used in each cycle or in some of the cycles.

In a further variant, the process of transferring a set of chips to the pockets or chip-receiving elements 238 may be repeated without first removing the previously-transferred chips from the pockets. This will build up a stack of chips in each pocket.

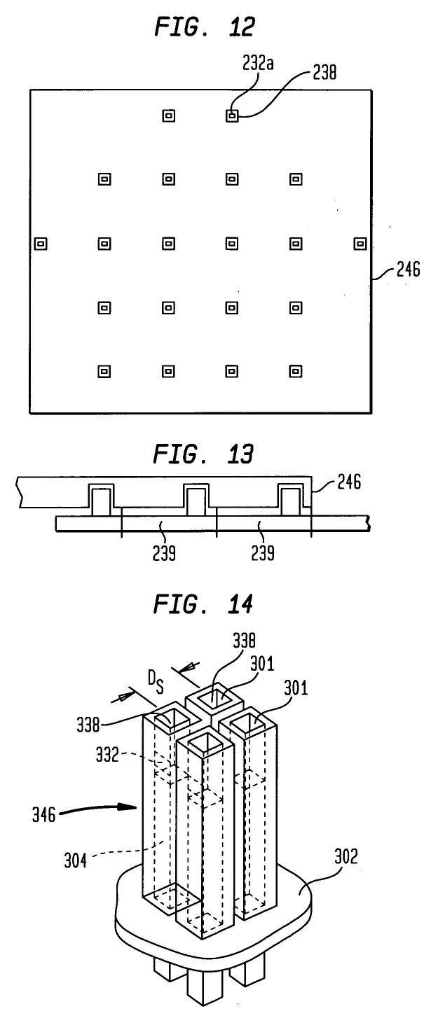

In yet another variant (FIG. 14), the array 346 of chip-receiving elements includes an array of individual generally tubular magazines 338 mounted on a common frame or base 302. Each magazine has an interior bore 301 just slightly larger than the dimensions of an individual chip. Here again, the center-to-center spacing distance Dₛ between individual magazines or individual chip-receiving elements 338 in the array 346 may be larger than the center-to-center spacing distances between the chips in the original array. In the manner discussed above with reference to FIGS. 10-12, successive sets of chips are transferred from the original array into the chip-receiving devices 338. Thus, a stack of individual chips 332 accumulates within the bore 301 of each chip-receiving element or magazine 338. Each magazine is provided with an interior pusher rod 304 disposed within its interior bore. Between successive chip transfer cycles, pusher rods 304 are retracted slightly so as to provide room for an additional chip at the top of the stack. The pusher rods prevent the chips from falling uncontrollably within the bores 301 as they are transferred from the original array. The resulting loaded magazines can be used in array form to transfer successive sets of chips to substrates. Alternatively, the loaded magazines may be detached from the base 302 and used individually so as to feed chips seriatim.

In a still further variant of the process discussed above with reference to FIGS. 8-12, the carrier 230 holding the original array may be provided with individual bores (not shown) communicating with each of the individual pockets 201, so that a vacuum supplied through these bores holds each chip in position. The transfer operation may be performed without the use of a separate tool by selectively releasing the vacuum applied to the bores associated with pockets at the locations of chips in the particular set to be transferred. Also, a positive gas pressure may be applied through the bores associated with the set of chips to be transferred so as to effectively blow the chips of the selected set out of their respective pockets and into the chip-receiving element.

A pocket array carrier as discussed above with reference to FIGS. 8-13 may be used as the chip array in a transfer process as discussed with reference to FIGS. 1-6, where the chips are transferred directly onto substrates and bonded to the substrates. Conversely, a film-type carrier such as the carrier 30 discussed above with reference to FIGS. 1-6 may be used as the carrier of an array in a process as discussed with reference to FIGS. 8-14, where the chips are transferred into fixtures rather than onto substrates. Also, in an embodiment where the chips are transferred onto substrates, it is not essential to provide all of the substrates in a single continuous array. For example, separate sheets of substrates may be used to provide successive arrays of substrates during each transfer cycle.

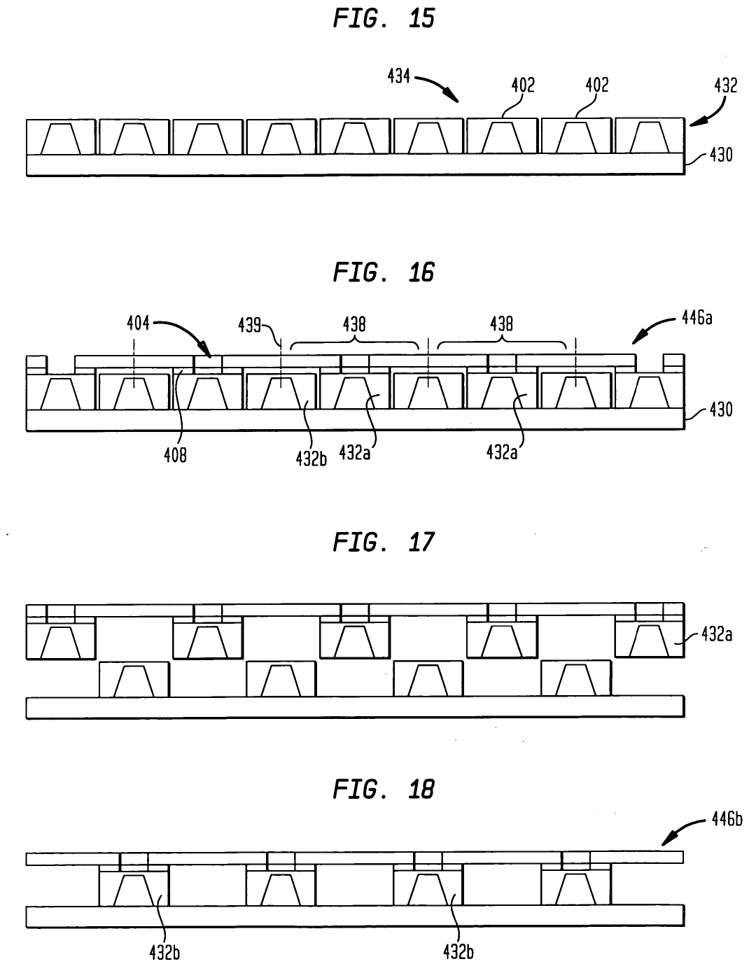

The present invention can be applied to handling and mounting of chips for manufacture of products other than RFID tags. For example, FIG. 15 depicts an array of chips 432 which are acoustically active chips. Each such chip includes a thin membrane 402 formed integrally with the remainder of the chip. Each such chip may include electronic circuits (not shown) sensitive to deformation of the membrane, so that the chip can act as a miniaturized microphone. In the stage of manufacture depicted in FIG. 15, the array of chips has been mounted on a carrier 430 which may be similar to the carriers discussed above. Preferably, the array of chips is formed by attaching the wafer incorporating the chips to the carrier, and then etching the chips so as to form the array 434 of individual chips.

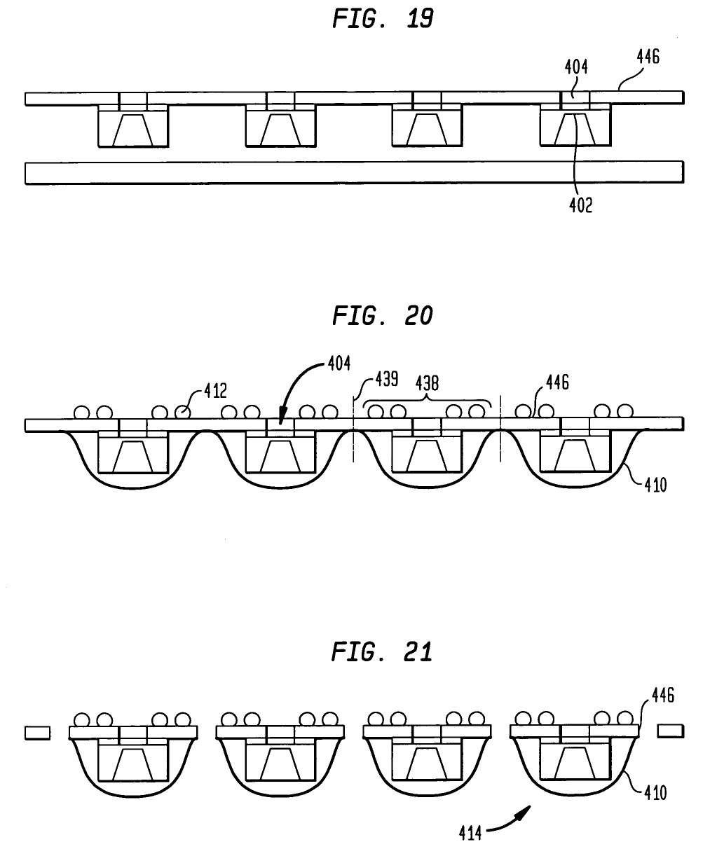

In the next stage of the process (FIG. 15), the array 434 of chips is juxtaposed with a first array 446 of substrates 438. In the embodiment depicted, the substrates of the first array are part of a larger continuous sheet, so that the substrates are connected to one another at the boundaries 439 between the substrates. Each substrate 438 includes a dielectric element, a hole 404 extending through the dielectric element near the center of the substrate and electrically-conductive elements (not shown) such as traces and terminals on the dielectric element of the substrate. The substrates are aligned with chips 432a of a first set, so that the holes of substrates 438 are aligned with the membranes 402 of the chips in this set. In this embodiment as well, other chips in the array, such as chips 432b, are not aligned with the substrates. Here again, the chips 432a in the first set are bonded and electrically-connected to the substrates 438, as by an isotropic conductive material 408 carried on the substrates. As in the embodiments discussed above, the chips 432a of the first set are released from the carrier 430 and, hence, are transferred to the substrates 438 of array 446. That array is then removed from the chip array, (carrying chips 432a with it (FIG. 17). The cycle of operations is repeated (FIGS. 18 and 19) using a further array of substrates 446b and transferring the second set of chips 432b of the original array to substrate array 446b. Here again, the membranes 402 of the individual chips are aligned with the holes 404 of the substrates.

In the next phase of the process (FIG. 20), a substrate array 446 with the chips 432 thereon is united with a sheet including numerous cup-like metallic shields 410. The shields 410 are engaged with the substrate and bonded to the rear or chip-facing side of the substrate (the side of the substrate facing downwardly in FIG. 20) around the periphery of each substrate 438. Desirably, the shields are also electrically connected to conductive elements of the substrate, as for example, by solder-bonding the shields to the conductive elements or by use of further anisotropic conductive adhesives (not shown). Bonding material such as solder balls 412 is applied to the conductive elements of each substrate on the front face of the substrate (opposite from the shields 410 and chips 432). The solder ball application process may be conducted before or after application of the shields or simultaneously therewith, as for example, in a common reflow operation. The substrate array 446 and the sheet of shields are then severed as by cutting through the substrate and shields at the boundaries 439 between substrates, so as to yield a plurality of individual units or packages 414.

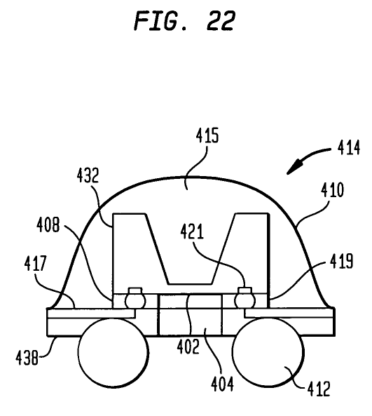

Each package 414 (FIGS. 21 and 22) provides a packaged acoustically-active semiconductor chip. The substrate 438 incorporated in the unit overlies the front face of the chip. The shield 410 overlies the rear face of the chip and the rear surface of the substrate 438 (the surface facing upwardly in FIG. 22). The shield 410 and the substrate cooperatively define a sealed volume 415. This volume is sealed by the juncture between the shield 410 and substrate 438 around the edges of the package, and is also sealed around the edges of holes 404 by the anisotropic conductive adhesive 408 applied during the chip-bonding process discussed above. The membrane 402 of the chip 432 is aligned with the hole 404 in the substrate 438. Thus, the front surface of the membrane (the surface facing downwardly in FIG. 22) is exposed to the exterior of the package for receipt of acoustic waves impinging on the package. The rear surface of the membrane (the surface facing upwardly in FIG. 22) is exposed to the sealed volume 415. As explained in greater detail in co-pending, commonly assigned U.S. Provisional Patent Application 60/549,176, filed Mar. 1, 2004, the disclosure of which is incorporated by reference herein, the sealed acoustic volume greatly enhances the acoustical response of the membrane. The chip acts to convert acoustic pressure waves impinging on membrane 402 from outside of the package into electrical signals, which are passed through the electrically-conductive elements of the substrate 438, including electrically conductive terminals 419, to the solder balls 412.

The packaged chip can act as a highly-sensitive microphone. The packaged chip can be surface-mounted or otherwise attached to a larger substrate (not shown) using common surface-mounting techniques. The shield 410, in addition to defining the sealed acoustical volume 415, also acts as an electromagnetic shield around chip 432. The substrate 438 may include electrically-conductive features such as a ground plane 417 in addition to traces and terminals 419, which connect the signal terminals 421 of the chip to the solder balls 412. Ground plane 417 desirably extends around the periphery of each substrate so as to provide a continuous solder-bonded seal at the periphery of the substrate and, hence, at the periphery of the sealed volume 415.

The structure discussed above with reference to FIG. 22 provides an extraordinarily compact and inexpensive packaged acoustically-active chip. Such a structure can be made by processes other than those discussed above. However, the process discussed above avoids significant problems inherent in attempts to handle and package acoustically-active chips on larger substrates. The membranes 402 incorporated in the chips can be damaged by conventional pick-and-place equipment which engage the chip with a vacuum chuck. Also, the acoustically-active chips typically are small and can be damaged by attempts to remove them from the chip array using tweezers or other mechanical devices. The process discussed above allows placement of small acoustically-active chips on substrates which are substantially larger than the chips themselves. Thus, the packaged chips can be of a size which facilitates surface-mounting.

As these and other variations and combinations of the features discussed above can be utilized without departing from the present invention as defined by the claims, the foregoing description of the preferred embodiments should be taken by way of illustration rather than by way of limitation of the invention as defined by the claims.

1. A method of handling chips comprising:
(a) performing a cycle of operations including juxtaposing
(i) an array of chips spaced apart from one another by chip spacing distances and
(ii) an array of chip-receiving elements spaced apart from one another by receiving element spacing distances different from said chip spacing distances
so that a set of said chips including a plurality of chips but less than all of said chips is aligned with a set of said chip-receiving elements and transferring said set of chips to said set of chip-receiving elements while said arrays are aligned with one another.

2. The method as claimed in claim 1 further comprising repeating said cycle of operations using the same or a different array of chips and using the same or a different array of chip-receiving elements so as to transfer a different set of chips to chip-receiving elements in each cycle.

3. The method as claimed in claim 2 wherein said receiving element spacing distances are larger than said chip spacing distances.

4. The method as claimed in claim 3 wherein said repeating step is performed so as to use a single array of chip-receiving elements in a plurality of cycles, whereby a plurality of sets of chips are transferred to said single array of chip-receiving elements.

5. The method as claimed in claim 4 wherein said array of chips extends in horizontal directions and said repeating step includes moving said array of chips or said single array of chip-receiving elements in at least one of said horizontal directions between successive cycles.

6. The method as claimed in claim 5 wherein said array of chip-receiving elements is in the form of an elongated strip and said moving step including the step of advancing the strip in a downstream direction between at least some of said successive cycles.

7. The method as claimed in claim 2 wherein said chip-receiving elements are substrates, the method further comprising attaching the transferred chips to said substrates.

8. The method as claimed in claim 7 wherein said array of chip-receiving elements includes a continuous or semi-continuous sheet of substrates.

9. The method as claimed in claim 8 wherein said repeating step includes advancing said sheet of substrates in a downstream direction between at least some of said cycles.

10. The method as claimed in claim 2 wherein said chip-receiving elements are holding fixtures.

11. The method as claimed in claim 10 further comprising the step of transferring said chips from said holding fixtures to substrates and attaching the chips to said substrates.

12. The method as claimed in claim 11 wherein said substrates are in the form of a sheet or strip having substrates spaced apart from one another by substrate spacing distances and said holding fixtures are spaced apart from one another by receiving element spacing distances equal to said substrate spacing distances or an integral multiple thereof, and said step of transferring said chips to said substrates includes simultaneously aligning a plurality of said holding fixtures with a plurality of said substrates and simultaneously transferring a plurality of chips to a plurality of substrates.

13. The method as claimed in claim 12 wherein said holding fixtures include pockets and said repeating step is performed so as to place successive sets of chips into the same pockets on successive cycles and thereby form a stack of chips in each pocket.

14. The method as claimed in claim 7 or claim 11 wherein said substrates include electrically-conductive elements, the method further comprising electrically connecting the transferred chips to the electrically-conductive elements of said substrates.

15. The method as claimed in claim 14 wherein said electrically-conductive elements of said substrates include antennas.

16. The method as claimed in claim 7 or claim 11 wherein said substrates include dielectric elements having holes therein and said chips include acoustically-active chips having membranes therein, said step of transferring said chips to said substrates including the step of aligning said membranes with said holes.

17. The method as claimed in claim 1 further comprising forming said array of chips, said forming step including attaching a wafer to a carrier and then severing the wafer so as to form individual chips and leave the chips in place on the carrier.

18. The method as claimed in claim 17 wherein said forming step further includes simultaneously transferring a plurality of said chips to another carrier.

19. The method as claimed in claim 1 wherein each said array of chips includes a plurality of chips bonded to a carrier, said step of transferring a set of chips to a set of chip-receiving elements including de-bonding only the chips in said set from said carrier.

20. A method of handling chips comprising the steps of:
(a) juxtaposing a carrier bearing chips at a plurality of chip locations with a plurality of chip-receiving elements; and
(b) transferring chips from said carrier to chip-receiving elements only at a first set of said chip locations without transferring chips from said carrier at a second set of chip locations interspersed with said first set of chip locations.

21. The method as claimed in claim 20 wherein said transferring step includes engaging said carrier with a tool having active elements spaced apart from one another so that said active elements are aligned with said first set of chip locations but not with said second set of chip locations.

22. The method as claimed in claim 21 wherein said tool includes a fixture having a blocking surface and said active elements include openings in said blocking surface, said transferring step including transferring the chips at said first set of chip locations through said openings.

23. The method as claimed in claim 21 wherein said active elements include raised elements on said tool.

24. A packaged acoustically-active chip comprising:
(a) a substrate including a dielectric element having front and rear surfaces and having a hole extending between said front and rear surfaces, said substrate also having electrically-conductive terminals exposed at said front surface;
(b) an acoustically-active chip having a membrane, said chip being mounted to said rear surface of said substrate with said membrane aligned with said hole, said chip being electrically connected to at least some of said terminals; and
(c) a hollow, electrically conductive shield mounted to the rear surface of said substrate, said shield covering said chip, said shield and said substrate cooperatively defining a cavity, said chip being disposed within said cavity.

25. A method of packaging chips comprising:
(a) mounting a plurality of acoustically-active chips to a plurality of substrates incorporated in a substrate sheet so that the chips overlie a rear surface of the sheet and so that membranes incorporated in the chips are aligned with holes extending through the substrates;
(b) mounting a shield sheet including a plurality of electrically conductive hollow shields to the rear surface of the sheet so that each shield covers a chip; and then
(c) severing the substrate sheet and the shield sheet so as to form a plurality of individual packages, each including a chip, a shield and a substrate.
